(19) United States
(12) Patent Application Publication
(10) Pub. No.: US 2005/0223101 A1
(43) Pub. Date: Oct. 6, 2005

(54) Computer-implemented method, system and program product for resolving prerequisites for native applications utilizing an open service gateway initiative ( OSGi) framework

(75) Inventor: Kent F. Hayes JR., Chapel Hill, NC (US)

Correspondence Address: HOFFMAN WARNICK & D'ALESSANDRO, LLC, 75 STATE STREET, 14TH FL, ALBANY, NY, 12207, US

(73) Assignee: International Business Machines Corporation, Armonk, NY (US)

(21) Appl. No.: 10/805,963

(22) Filed: Mar. 22, 2004

(51) Int. Cl. G06F 15/16

(52) U.S. Cl. 709/228

(57) ABSTRACT

Under the present invention a native application intended for a client device is packaged within an OSGi bundle along with corresponding dependency information that identifies any prerequisites the native application might have. The client device will then be polled to determine if it has the necessary prerequisites. If not, the prerequisites will be obtained and packaged within their own OSGi bundles (i.e., if they have not been previously packaged). Thereafter, the various OSGi bundles containing the native application and any needed prerequisites will be loaded on the client device.

### BACKGROUND OF THE INVENTION

1. Field of the Invention

In general, the present invention relates to a computer-implemented method, system and program product for resolving prerequisites for native applications in an Open Service Gateway Initiative (OSGi) framework. Specifically, the present invention allows prerequisites for native applications to be resolved using OSGi technology.

2. Related Art

As computer networking has become more advanced, a standard known as the Open Service Gateway Initiative (OSGi) has been developed. The OSGi is an industry plan to provide a standard way to deliver managed services to devices and local networks. With such a standard, home users could, for example, change the setting on their thermostat from a remote location (e.g., the workplace). In general, the OSGi provides a good framework for developing application components. Under the OSGi, a basic component is known as an OSGi bundle. An OSGi application can be made up of combinations/suites of bundles that might share common functionality. To this extent, the OSGi allows developers to define the dependencies between the bundles such as the packages and services required by the bundles. The OSGi can also determine whether a device has the necessary packages and services. In a typical implementation, an OSGi architecture will include, among other components, a server and one or more client devices. Each client device will have an OSGi environment within which OSGi applications are deployed. Using a management program on the server, the functions of the OSGi applications can be controlled.

Unfortunately, as convenient as OSGi technology can be, it fails to provide an efficient way to resolve prerequisites for native applications that are to be loaded on a client device. Specifically, a particular native application might require that the client device have resources such as other native applications, databases, etc., to be properly run. If the client device fails to have the necessary prerequisites, the resource shortages should be addressed, or the native application should not be loaded.

In view of the foregoing, there exists a need for a computer-implemented method, system and program product for both expressing and resolving prerequisites for native applications in an Open Service Gateway Initiative (OSGi) framework. Specifically, a need exists whereby prerequisites for native applications to be loaded on a client device can be resolved using OSGi technology.

### SUMMARY OF THE INVENTION

In general, the present invention provides a computer-implemented method, system and program product for resolving prerequisites for native applications in an Open Service Gateway Initiative (OSGi) framework. Specifically, under the present invention a native application intended for a client device is packaged within an OSGi bundle along with corresponding dependency information that identifies any prerequisites the native application might require to properly run on the client device. The client device will then be polled to determine if it has the necessary prerequisites. If not, the prerequisites will be obtained and packaged within their own OSGi bundles (i.e., if they have not been previously packaged). Thereafter, the various OSGi bundles containing the native application and any needed prerequisites will be loaded on the client device.

A first aspect of the present invention provides a computer-implemented method for resolving prerequisites for native applications in an Open Service Gateway Initiative (OSGi) framework, comprising: packaging a native application for a client device and corresponding dependency information within a first OSGi bundle on a server, wherein the corresponding dependency information specifies at least one prerequisite on which the native application depends for proper operation on the client device; polling the client device to determine if the client device has the at least one other prerequisite; obtaining the at least one prerequisite if the client device does not have the at least one prerequisite; and loading the at least one prerequisite and the native application on the client device.

A second aspect of the present invention provides a computer-implemented method for resolving prerequisites for native applications in an Open Service Gateway Initiative (OSGi) framework, comprising: packaging a native application for a client device and corresponding dependency information within a first OSGi bundle on a server, wherein the dependency information specifies at least one prerequisite on which the native application depends for proper operation on the client device; polling the client device to determine if the client device has the at least one other prerequisite; obtaining the at least one prerequisite if the client device does not have the at least one prerequisite, wherein the at least one prerequisite is packaged within a second OSGi bundle that is accessible to the server; and installing the first OSGi bundle and the second OSGi bundle within an OSGi environment of the client device.

A third aspect of the present invention provides a computerized system for resolving prerequisites for native applications in an Open Service Gateway Initiative (OSGi) framework, comprising: a packaging system for packaging a native application for a client device and corresponding dependency information within a first OSGi bundle on a server, wherein the dependency information specifies at least one prerequisite on which the native application depends for proper operation on the client device; a communication system for polling the client device to determine if the client device has the at least one other prerequisite; a resolution system for obtaining the at least one prerequisite if the client device does not have the at least one prerequisite, wherein the at least one prerequisite is packaged within a second OSGi bundle that is accessible to the server; and a bundle loading system for loading the first OSGi bundle and the second OSGi bundle on the client device.

A fourth aspect of the present invention provides a program product stored on a recordable medium for resolving prerequisites for native applications in an Open Service Gateway Initiative (OSGi) framework, which when executed, comprises: program code for packaging a native application for a client device and corresponding dependency information within a first OSGi bundle on a server, wherein the dependency information specifies at least one prerequisite on which the native application depends for proper operation on the client device; program code for polling the client device to determine if the client device has the at least one other prerequisite; program code for obtaining the at least one prerequisite if the client device does not have the at least one prerequisite, wherein the at least one prerequisite is packaged within a second OSGi bundle that is accessible to the server; and program code for loading the first OSGi bundle and the second OSGi bundle on the client device.

Therefore, the present invention provides a computer-implemented method, system and program product for resolving prerequisites for native applications in an Open Service Gateway Initiative (OSGi) framework.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative system for resolving prerequisites for native applications in an Open Service Gateway Initiative (OSGi) Framework according to the present invention.

FIG. 2 depicts the system of FIG. 1 in greater detail.

FIG. 3 depicts a method flow diagram according to the present invention.

It is noted that the drawings of the invention are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

For convenience purposes, the Detailed Description of the Drawings will have the following sections:

I. General Description

II. Detailed Example

I. General Description

As indicated above, the present invention provides a computer-implemented method, system and program product for resolving prerequisites for native applications in an Open Service Gateway Initiative (OSGi) framework. Specifically, under the present invention a native application intended for a client device is packaged within an OSGi bundle along with corresponding dependency information that identifies any prerequisites the native application might have to properly run on the client device. The client device will then be polled to determine if it has the necessary prerequisites. If not, the prerequisites will be obtained and packaged within their own OSGi bundles (i.e., if they have not been previously packaged). Thereafter, the various OSGi bundles containing the native application and any needed prerequisites will be loaded on the client device.

As used herein, the term “prerequisite” is intended to refer to any type of resource that a native application might need to run/operate properly (e.g., as intended) on a client device. Examples of prerequisites include, among other things, other native applications, databases, packages, services, etc. As known, under the OSGi, a “package” is similar to a JAVA package and a “service” is a certain type of interface.

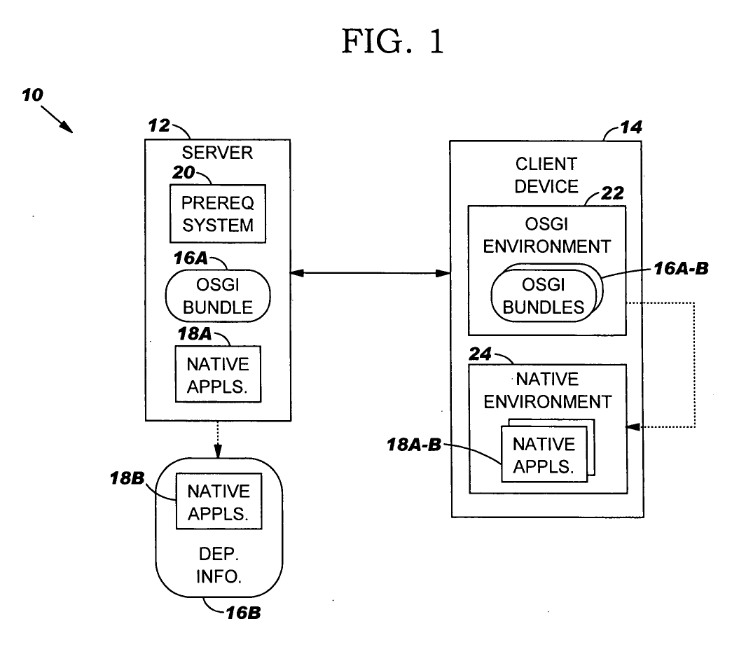

Referring now to FIG. 1, an illustrative system 10 for resolving prerequisites for native applications using OSGi bundles according to the present invention is shown. As depicted, system 10 includes server 12 and client device 14 (a single client device is shown for illustrative purposes only). It should be understood that the architecture shown herein is illustrative only and will likely include other known components not shown. For example, a typical OSGi framework would likely include a device, OSGi agent(s) (on client device 14), a device management server and one or more application servers. Moreover, it should be understood that a typical OSGi framework could include multiple servers 12 and a network dispatcher. In any event, client device 14 is intended to represent any type of computerized device capable of communicating over a network. For example, client device 14 could be a desktop computer (e.g., WIN-32-based, Linux based, etc.), a hand held device, a set top box, a home appliance, a security system, etc. In any event, server 12 and client device 14 typically communicate over any type of network such as the Internet, a local area network (LAN), a wide area network (WAN), a virtual private network (VPN), etc. As such, communication between server 12 and client device 14 could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, client device 14 could utilize an Internet service provider to establish connectivity to server 12.

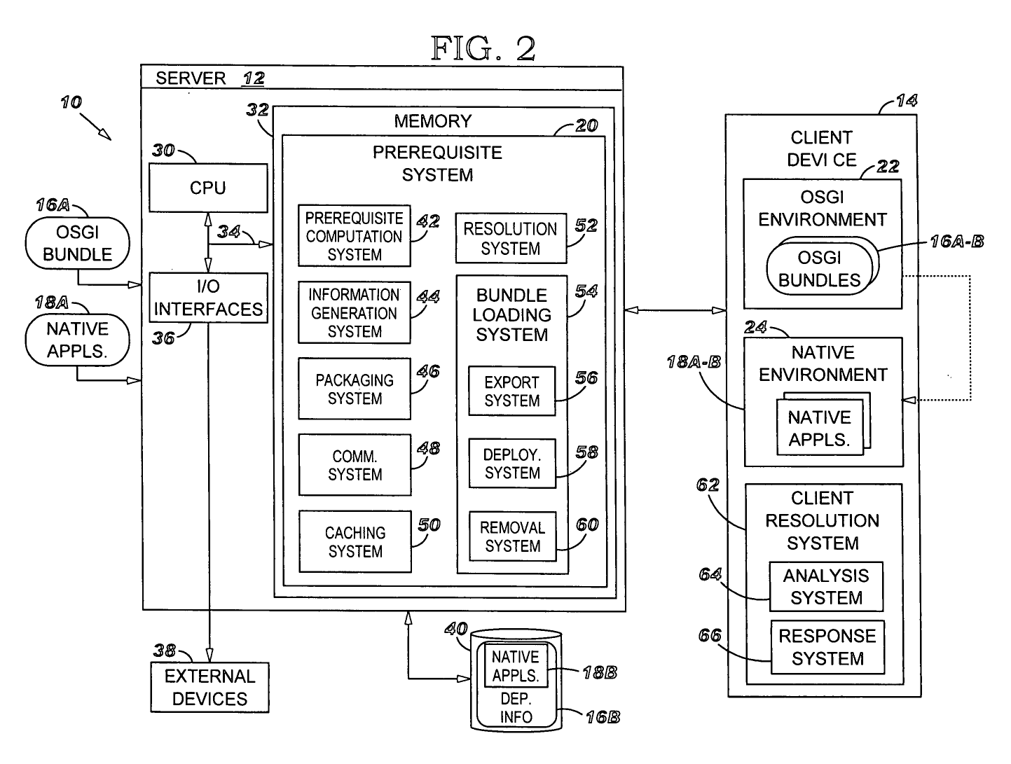

Under the present invention, server 12 will be provided with one or more OSGi bundles 16A and a native application 18A to be loaded on client device 14. As known, an OSGi bundle is essentially a JAR file with certain characteristics which enable it to effectively interact with the OSGi framework. As such, OSGi bundle 16 has the ability to be controlled in a well defined manner. To enable resolution of prerequisites for native application 18A, prerequisite system 20 is shown on server 12. Prerequisite system 20 will be further described below in conjunction with FIG. 2. However, it should be understood that prerequisite system 20 can include any components of, or can be incorporated within any type of OSGi management program now known or later developed.

In any event, assume that native application 18A is to be loaded on client device 14. Under the present invention, prerequisite system 20 will first determine/identify the prerequisites for native application 18A. This can be accomplished by accessing a stored reference based on the identity and version of native application 18, or based on a detailed analysis thereof by prerequisite system 20. Regardless, once the prerequisites are known, corresponding dependency information will be generated. The dependency information typically indicates the one or more prerequisites on which native application 18 depends for proper operation on client device 14. For example, if native application 18A requires another native application 18B (e.g., native application “Y” version 2.0) to properly run on client device 14, dependency information will be generated that specifies this information. Once the dependency information is determined/generated, it will be packaged along with native application 18A within OSGi bundle 16A. Once packaged, OSGi bundle 16A will be registered with server 20. Registration typically includes storing the identity of native application 18A along with the dependency information in a registry maintained in local memory, cache or the like.

Thereafter, client device 14 will be polled to determine whether it contains the necessary prerequisites (e.g., native application “Y” version 2.0). The response from client 14 will be cached on server 12 so that the same questions do not need to be repeatedly asked. Specifically, as will be further described below, server 12 can maintain a running table of resources that are known to exist, or not to exist, on client device 14. If native application 18B was already known not to exist on client device 14 from a previous polling, client device 14 need not be re-polled. Regardless, prerequisite system 20 will obtain any of the necessary prerequisites that client device 14 lacks. In a typical embodiment, the prerequisites are obtained by checking the registry for resources that are known to exist to server 12. For example, if native application 18B was previously packaged within another OSGi bundle 16B with its own dependency information (as shown), it will exist in the registry.

This process occurs recursively meaning that the resolution is continuously repeated until all prerequisites are resolved, or until it is determined that the prerequisites cannot be resolved within the resource limitations of the device. Recursive resolution is especially useful since any quantity or hierarchy of prerequisites might need resolution (e.g., prerequisites such as native application 18B could themselves have prerequisites).

In any event, once the prerequisites are completely resolved, prerequisite system 20 will load the final set of OSGi bundles 16A-B on client device 14. Typically, the loading process includes server 12 sending client device 14 an instruction(s) pertaining the order in which OSGi bundles 16A-B should be loaded. OSGi bundles 16A-B will then be installed within OSGi environment 22 of client device 14. Once installed, the OSGi bundles 16A-B will be deployed to native environment 24 (e.g., a WIN-32 environment, Linux environment, etc.), and then native applications 18A-B will be removed OSGi bundles 16A-B. At that point, only native applications 18A-B will remain in native environment 24, while OSGi bundles 16A-B will remain in OSGi environment 22. Once native applications 18A-B are loaded on client, the running table of resources maintained by server can be updated to avoid unnecessary polling in the future.

II. Detailed Example

Referring now to FIG. 2, a more detailed diagram of FIG. 1 is shown. As shown, server 12 generally comprises central processing unit (CPU) 30, memory 32, bus 34, input/output (I/O) interfaces 36, external devices/resources 38 and storage unit 40. CPU 30 may comprise a single processing unit, or be distributed across one or more processing units in one or more locations, e.g., on a client and computer system. Memory 32 may comprise any known type of data storage and/or transmission media, including magnetic media, optical media, random access memory (RAM), read-only memory (ROM), a data cache, etc. Moreover, similar to CPU 30, memory 32 may reside at a single physical location, comprising one or more types of data storage, or be distributed across a plurality of physical systems in various forms.

I/O interfaces 36 may comprise any system for exchanging information to/from an external source. External devices/resources 38 may comprise any known type of external device, including speakers, a CRT, LCD screen, handheld device, keyboard, mouse, voice recognition system, speech output system, printer, monitor/display, facsimile, pager, etc. Bus 34 provides a communication link between each of the components in server 12 and likewise may comprise any known type of transmission link, including electrical, optical, wireless, etc.

Storage unit 40 can be any system (e.g., database) capable of providing storage for information under the present invention. Such information could include, for example, resources such as native applications, OSGi bundles, dependency information, a registry, etc. As such, storage unit 40 could include one or more storage devices, such as a magnetic disk drive or an optical disk drive. In another embodiment, storage unit 40 includes data distributed across, for example, a local area network (LAN), wide area network (WAN) or a storage area network (SAN) (not shown). Although not shown, additional components, such as cache memory, communication systems, system software, etc., may be incorporated into server. In addition, it should also be appreciated that although not shown, client device 14 would likely include computerized components similar to server 12.

Shown in memory 32 of server 12 is prerequisite system 20 which includes prerequisite computation system 42, information generation system 44, packaging system 46, communication system 48, caching system 50, resolution system 52 and bundle loading system 54 that itself includes export system 56, deployment system 58 and removal system 60. It should be understood that each of these systems includes program code/logic for carrying out the functions described herein. To this extent, the systems could be realized as plugins or the like. Regardless, when it is desired to load native application 18A on client device 14, any perquisites therefore will be identified/determined and then resolved. Specifically, prerequisite computation system 42 will first determine the prerequisites needed for proper operation of native application 16A. Such prerequisites could include other native applications such as native application 18B, a database such as a DB2 database, etc. As indicated above, the prerequisites can be computed by accessing information pertaining to native application 16A in cache memory, storage unit 40 or the like. In another embodiment, prerequisite computation system 42 could include logic to analyze native application 18A and compute the prerequisites.

In either event, once the prerequisites are determined, information generation system 44 will generate corresponding dependency information that specifies those prerequisites. For example, assume that native application 16A is formally entitled “native application “X” version 1.0.” Further assume that native application 18A requires native application 18B, which is entitled “native application “Y” version 2.0,” in order to properly run on client device 14. In this case, the dependency information for native application 18A would resemble the following:
Import: Native Application “Y” version 2.0

It should be appreciated that this dependency information can be optimally expressed in multiple different ways within the OSGi bundle that allow the dependencies to be tied into the standard OSGi framework. For example, the dependency information for a native application may be expressed as package-import statements in the OSGi bundle's (i.e., the OSGi bundle packaging the native application) manifest file for distribution. The following is an example of such:
Import-Package NativeAppY;specification-version=2.0
   The OSGi bundle containing native application Y, version 2.0, would have the following expression in it's manifest:
Export-Package NativeAppY;specification-version=2.0
   This expression declares that the OSGi bundle provides the associated native application. In addition, the name and version of the native application could be represented in the name and version of the OSGi bundle containing the application.

Still yet, the present invention could express that one bundle is directly dependent on another bundle (as opposed the dependency specification utilizing packages and services). In this case, the name and version of the native application would be represented in the name and version of the OSGi bundle containing the native application. The dependency of one native application on a name and version of another application would be expressed as an OSGi bundle dependency between the native application to be loaded and the prerequisite(s) bundles containing prerequisite applications (native and otherwise) required for proper operation of the native application.

In yet another embodiment of the invention, services information corresponding to the native application may be expressed in the OSGi bundle's manifest. Specifically, an OSGi service may be exported from the OSGi bundle containing the native application, which is based on the name and version of the native application contained therein. Prerequisites that the native application requires could then be expressed as one or more services imported (i.e., required) by the native application.

Regardless of the embodiment used, the “Import” language is used to indicate that native application “Y” version 2.0 is needed for proper running of native application 18A. It should be appreciated that since the resolution process of the present invention is performed recursively, prerequisite computation system 42 could also determine any prerequisites for native application 18B. For example, if native application 18B requires another native application (not shown) entitled “native application “Z”, version 3.0” in order to properly run on client device 14, information generation system 44 could also generate the following dependency information for native application 18B:
Import: Native Application “Z”, version 3.0
   Still yet, it should be understood that the dependency information generated could also specify the identities of the native applications 18A-B themselves as “exportable” resources that can be used by other native applications. In this case, the dependency information could resemble the following for native applications 18A-B:

### Native Application 18A

Import: Native Application “Y” version 2.0
Export: Native Application “X” version 1.0

### Native Application 18B

Import: Native Application “Z” version 3.0
Export: Native Application “Y” version 2.0
   In any event, once the dependency information has been generated for native application 18A, it will be packaged along with native application 18A itself within OSGi bundle 16A by packaging system 46. This will form a link between OSGi bundle 16A and native application 18A. The linkage could be performed generically if the environment permits (e.g., WIN-32, etc.), or more specifically for native application 18A via running scripts, executable file, etc. In any event, once native application 18A is packaged within OSGi bundle 16A, it will be registered (e.g., in the registry) by packaging system 46 with server 12 (e.g., in storage unit 40 and/or cache). In general, the registration process includes registering both native application 18A as well as any dependencies (e.g., “import” or “export” criteria as set forth in the dependency information). This allows server 12 to have a running list of exactly what native applications 18A are available, within which OSGi bundles, and any prerequisites the native applications might contain. For example, native application 18A will be registered as being packaged within OSGi bundle 16A, and requiring native application 18B in order to properly run on client device 14.

Thereafter, communication system 48 will check its running table to see if client device 14 has the needed prerequisites. If the list does not provide positive indication of the presence of native application 18A on client device 14, communication system 44 will poll client device 14 by send the needed prerequisites thereto. This communication need not be initiated by server 12. Rather it could be made in response to a request by client device 14 (e.g., by an agent thereon). Regardless, upon receipt of the communication from server, analysis system 64 within client resolution system 62 will analyze the prerequisites in view of available resources and determine whether all needed prerequisites are present. This information is typically determined from cache on client device 14. To this extent, client device 14 should maintain up to date information concerning its available computer resources, packages and services. After the analysis, response system 66 will generate and send a response back to server 12. The response will identify any resource limitations of client device 14. For example, if client device 14 lacks native application 18B, this limitation would be noted in the response that is sent back to server 12.

Upon receipt, caching system 50 will cache the response for future reference and update the table of resources known to exist (or not to exist) on client device 14. Thereafter, resolution system 52 will begin the process of recursively resolving the prerequisites. Typically, this involves identifying the resources (e.g., within other OSGi bundles) that fulfill the prerequisites of native application 18A. Thus, for example, resolution system 52 would attempt to identify and obtain an OSGi bundle that has native application 18B. In identifying native application 18B, resolution system 52 would check the registry of previously registered packaged native applications. As can be seen in FIG. 2, native application 18B was previously packaged within OSGi bundle 16B. Similar to native application 18A, when native application 18B was packaged within OSGi bundle 16B, it was subsequently registered. Accordingly, resolution system 52 should be able to find native application 18B by checking the registry. The resolution process could continue for native application 18B and all corresponding hierarchies of prerequisites.

In this example, assume that all prerequisites have been resolved and that only OSGi bundles 16A-B need to be loaded on client device 14. In this event, export system 56 of bundle loading system 54 will install OSGi bundles 16A-B (having native applications 18A-B therein) within OSGi environment 22 of client device 14. In installing the bundles 16A-B in this manner, export system 56 could pass an instruction to client device 14 specifying the precise order in which native applications 18A-B should be installed. In any event, deployment system 58 will thereafter deploy te native code contained within the OSGi bundles 16A-B to native environment 24. Once deployed, removal system 60 may optionally remove native applications 18A-B from within OSGi bundles 16A-B. At this point, native applications 18A-B are deployed in native environment 24, while OSGi bundles 16A-B are deployed within OSGi environment.

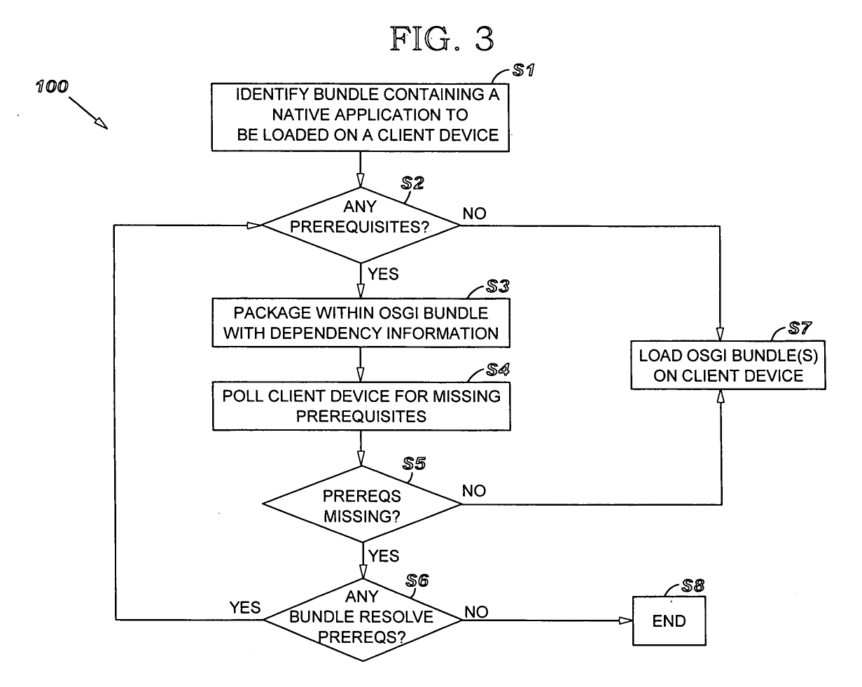

Referring now to FIG. 3, a method flow diagram 100 according to the present invention is shown. As depicted, first step S1 is to identify the bundle containing the native application to be loaded on a client device. Second step S2 is to determine whether the native application has any prerequisites. If not, the native application is packaged within an OSGi bundle and loaded on the client device in step S7. If, however, the native application has prerequisites, the native application is packages within an OSGi bundle along with corresponding dependency information in step S3. As indicated above, the dependency information specifies any prerequisite(s) on which the native application depends for proper operation on the client device. Fourth step S4 is to poll the client device to determine if the client device has the at least one other prerequisite. If it is determined in step S5, that the client device does not lack any of the prerequisites, the OSGi bundle containing the native application and the dependency information is loaded on the client device in step S7. If, however, the client device was determined in step S5 to be lacking any of the prerequisite(s), the server will attempt locate one or more other registered OSGi bundles that provide the missing prerequisites in step S6. If none can be found, the process ends in step S8. If, however, such OSGi bundles are found, the process will be repeated recursively from step S2 for such bundles. Once all prerequisites have been resolved, all necessary OSGi bundles will be loaded on the client device in step S7.

It should be understood that the present invention can be realized in hardware, software, or a combination of hardware and software. Any kind of computer system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, the illustrative representation of prerequisite system 20 shown in FIG. 2 is not intended to be limiting. That is, the functions of the present invention described herein could be represented by a different configuration of systems.

1. A computer-implemented method for resolving prerequisites for native applications in an Open Service Gateway Initiative (OSGi) framework, comprising:
packaging a native application for a client device and corresponding dependency information within a first OSGi bundle on a server, wherein the corresponding dependency information specifies at least one prerequisite on which the native application depends for proper operation on the client device;
polling the client device to determine if the client device has the at least one other prerequisite;
obtaining the at least one prerequisite if the client device does not have the at least one prerequisite; and
loading the at least one prerequisite and the native application on the client device.

2. The method of claim 1, further comprising registering the packaged native application and first OSGi bundle after the packaging step, wherein the registering step comprises storing the corresponding dependency information.

3. The method of claim 1, wherein the polling step comprises:
identifying the at least one prerequisite to the client device; and
receiving a response from the client device, wherein the response indicates whether the client device has the at least one prerequisite.

4. The method of claim 1, further comprising:
determining the at least one prerequisite, prior to the packaging step; and
generating the corresponding dependency information based on the at least one prerequisite.

5. The method of claim 1, wherein the at least one prerequisite comprises another native application.

6. The method of claim 1, wherein the at least one prerequisite is packaged with corresponding dependency information within a second OSGi bundle, and wherein the obtaining step comprises obtaining the second OSGi bundle.

7. The method of claim 6, wherein loading step comprises:
installing the first OSGi bundle and the second OSGi bundle within an OSGi environment of the client device;
deploying the first OSGi bundle and the second OSGi bundle within a native environment of the client device; and
removing the native application from within the first OSGi bundle and the at least one prerequisite from within the second OSGi bundle.

8. The method of claim 1, wherein the method is performed recursively.

9. The method of claim 1, wherein the dependency information is expressed as a package import statement.

10. The method of claim 1, wherein a name and version of the native application is represented in a name and version of the OSGi bundle.

11. A computer-implemented method for resolving prerequisites for native applications in an Open Service Gateway Initiative (OSGi) framework, comprising:
packaging a native application for a client device and corresponding dependency information within a first OSGi bundle on a server, wherein the dependency information specifies at least one prerequisite on which the native application depends for proper operation on the client device;
polling the client device to determine if the client device has the at least one other prerequisite;
obtaining the at least one prerequisite if the client device does not have the at least one prerequisite, wherein the at least one prerequisite is packaged within a second OSGi bundle that is accessible to the server; and
installing the first OSGi bundle and the second OSGi bundle within an OSGi environment of the client device.

12. The method of claim 11, wherein the first OSGi bundle and the second OSGi bundle are registered on the server after being packaged with the first native application and the at least one prerequisite.

13. The method of claim 11, wherein the polling step comprises:
identifying the at least one prerequisite to the client device; and
receiving a response from the client device, wherein the response indicates whether the client device has the at least one prerequisite.

14. The method of claim 11, further comprising:
determining the at least one prerequisite, prior to the packaging step; and
generating the dependency information based on the at least one prerequisite.

15. The method of claim 11, wherein the at least one prerequisite comprises another native application.

16. The method of claim 11, further comprising:
deploying the first OSGi bundle and the second OSGi bundle within a native environment of the client device; and
removing the native application from within the first OSGi bundle and the at least one prerequisite from within the second OSGi bundle.

17. The method of claim 11, wherein the at least one prerequisite is packaged with corresponding dependency information within the second OSGi bundle.

18. The method of claim 11, wherein the method is performed recursively.

19. A computerized system for resolving prerequisites for native applications in an Open Service Gateway Initiative (OSGi) framework, comprising:
a packaging system for packaging a native application for a client device and corresponding dependency information within a first OSGi bundle on a server, wherein the dependency information specifies at least one prerequisite on which the native application depends for proper operation on the client device;
a communication system for polling the client device to determine if the client device has the at least one other prerequisite;
a resolution system for obtaining the at least one prerequisite if the client device does not have the at least one prerequisite, wherein the at least one prerequisite is packaged within a second OSGi bundle that is accessible to the server; and
a bundle loading system for loading the first OSGi bundle and the second OSGi bundle on the client device.

20. The system of claim 19, wherein packaging system further registers the first OSGi bundle after being packaged with the first native application.

21. The system of claim 19, wherein the communication system identifies the at least one prerequisite to the client device and receives a response from the client device that indicates whether the client device has the at least one prerequisite.

22. The system of claim 19, further comprising:
a prerequisite identification system for determining the at least one prerequisite; and
an information generation system for generating the dependency information based on the at least one prerequisite.

23. The system of claim 19, wherein the at least one prerequisite comprises another native application.

24. The system of claim 19, wherein bundle loading system comprises:
an export system for installing the first OSGi bundle and the second OSGi bundle within the OSGi environment of the client device;
a deployment system for deploying the first OSGi bundle and the second OSGi bundle within a native environment of the client device; and
a removal system for removing the native application from within the first OSGi bundle and the at least one prerequisite from within the second OSGi bundle.

25. The system of claim 19, wherein the at least one prerequisite is packaged with corresponding dependency information within the second OSGi bundle.

26. The system of claim 19, wherein the client device includes:
an analysis system for determining whether the client device has the at least one prerequisite; and
a response system for generating and sending a response to the server.

27. The system of claim 19, wherein the dependency information specifies an identity and a version of the at least one prerequisite required by the native application.

28. The system of claim 27, wherein the at least one prerequisite comprises another native application.

29. The system of of claim 19, wherein the dependency information is expressed as a package import statement.

30. The system of claim 19, wherein a name and version of the native application is represented in a name and version of the OSGi bundle.

31. A program product stored on a recordable medium for resolving prerequisites for native applications in an Open Service Gateway Initiative (OSGi) framework, which when executed, comprises:
program code for packaging a native application for a client device and corresponding dependency information within a first OSGi bundle on a server, wherein the dependency information specifies at least one prerequisite on which the native application depends for proper operation on the client device;
program code for polling the client device to determine if the client device has the at least one other prerequisite;
program code for obtaining the at least one prerequisite if the client device does not have the at least one prerequisite, wherein the at least one prerequisite is packaged within a second OSGi bundle that is accessible to the server; and
program code for loading the first OSGi bundle and the second OSGi bundle on the client device.

32. The program product of claim 31, wherein program code for packaging further registers the first OSGi bundle after being packaged with the first native application.

33. The program product of claim 31, wherein the program code for polling identifies the at least one prerequisite to the client device and receives a response from the client device that indicates whether the client device has the at least one prerequisite.

34. The program product of claim 31, further comprising:
program code for determining the at least one prerequisite; and
program code for generating the dependency information based on the at least one prerequisite.

35. The program product of claim 31, wherein the at least one prerequisite comprises another native application.

36. The program product of claim 31, further comprising:
program code for installing the first OSGi bundle and the second OSGi bundle within an OSGi environment of the client device;
program code for deploying the first OSGi bundle and the second OSGi bundle within a native environment of the client device; and
a removal system for removing the native application from within the first OSGi bundle and the at least one prerequisite from within the second OSGi bundle.

37. The program product of claim 31, wherein the at least one prerequisite is packaged with corresponding dependency information within the second OSGi bundle.

38. The program product of claim 31, wherein the client device includes:
program code for determining whether the client device has the at least one prerequisite; and
program code for generating and sending a response to the server.

39. The program product of claim 31, wherein the dependency information is expressed as a package import statement.

40. The program product of claim 31, wherein a name and version of the native application is represented in a name and version of the OSGi bundle.
